(19) United States
(12) Patent Application Publication
(10) Pub. No.: US 2019/0149454 A1
(43) Pub. Date: May 16, 2019

(54) BYPASS AND NON-BYPASS TECHNIQUES FOR ROUTING SIGNALS IN COMPLEX COMPUTING NETWORKS

(71) Applicant: Jeffrey W. Mankoff, Dallas, TX (US)

(72) Inventor: Jeffrey W. Mankoff, Dallas, TX (US)

(21) Appl. No.: 15/879,409

(22) Filed: Jan. 24, 2018

Related U.S. Application Data
(63) Continuation-in-part of application No. 14/330,768, filed on Jul. 14, 2014, now abandoned.
Application No. 14/330,768 is a continuation of application No. 13/584,632, filed on Aug. 13, 2012, now Pat. No. 8,825,522.
Application No. 13/584,632 is a continuation of application No. 13/266,210, filed on Oct. 25, 2011, now abandoned.
Application No. 13/266,210 is a continuation of application No. 11/381,507, filed on May 3, 2006, now Pat. No. 8,036,934.
Application No. 11/381,507 is a division of application No. 10/262,767, filed on Oct. 1, 2002, now Pat. No. 7,593,862.
Application No. 10/262,767 is a continuation-in-part of application No. 10/081,257, filed on Feb. 22, 2002, now abandoned.
Application No. 10/081,257 is a continuation-in-part of application No. 09/611,672, filed on Jul. 7, 2000, now Pat. No. 6,868,426.
(60) Provisional application No. 60/142,611, filed on Jul. 7, 1999.
(60) Provisional application No. 60/191,352, filed on Mar. 22, 2000.

(51) Int. Cl. H04L 12/707; H04L 12/40; H04L 12/721

(52) U.S. Cl. CPC H04L 45/22; H04L 45/38; H04L 12/40169

(57) ABSTRACT

This disclosure is directed to bypass and non-bypass techniques for routing signals in a computing network. In some embodiments, a method is provided for bypass routing computing operation information in a computing network. The method comprises: receiving, by a computing device, computing operation information comprising first information; recognizing, by the computing device, that the computing operation information relates at least in part to a first computing operation that is different from a second computing operation related to a computing operation-processing network; and routing, by the computing device, a first message comprising information related to the first computing operation to a first computing operation-processing computing device while bypassing the computing operation-processing network related to the second computing operation.

### TECHNICAL FIELD

This disclosure is directed to bypass and non-bypass techniques for routing signals in a complex computing network, suitably classified in USPC 709/219 (Art Unit 2454).

### BACKGROUND

There is a need for efficiently routing signals in a complex computing network with heavy data traffic.

### BRIEF SUMMARY

In some embodiments, a method is provided of bypass routing computing operation information in a computing network. The method comprises: receiving, by a computing device, computing operation information comprising first information; recognizing, by the computing device, that the computing operation information relates at least in part to a first computing operation that is different from a second computing operation related to a computing operation-processing network; and routing, by the computing device, a first message comprising information related to the first computing operation to a first computing operation-processing computing device while bypassing the computing operation-processing network related to the second computing operation.

In some embodiments, the first computing operation is processed at the first computing operation-processing computing device.

In some embodiments, the first computing operation-processing computing device returns a second message related at least in part to the processing of the first computing operation to the computing device.

In some embodiments, the first computing operation-processing computing device is further to determine whether a request in the information related to the first computing operation is eligible for approval.

In some embodiments, the computing device comprises a smart computing device.

In some embodiments, the first computing operation comprises a computing adjustment operation.

In some embodiments, the first computing operation comprises a computing redemption operation.

In some embodiments, the second computing operation comprises an association computing operation.

In some embodiments, the first message is routed to the first computing operation-processing computing device via a third computing device.

In some embodiments, a method is provided of transforming and routing computing operation information using a computing device. The method comprises: receiving, by a computing device, computing operation information comprising first information; recognizing, by the computing device, that the computing operation information also comprises information related to a computing transformation operation; performing, by the computing device, the computing transformation operation to produce transformed first information; and routing, by the computing device, a message comprising a request for the transformed first information to a second computing device via a network.

In some embodiments, the computing transformation operation is different from a computing processing operation related to a computing processing-operation network.

In some embodiments, the message is routed to the second computing device while bypassing the computing processing-operation network related to the computing processing operation.

In some embodiments, the computing transformation operation is performed at the second computing device, and wherein the second computing device returns a second message related at least in part to the performing of the computing transformation operation to the computing device.

In some embodiments, the computing device comprises a smart computing device.

In some embodiments, the transforming of the computing operation information is rooted in computing technology.

In some embodiments, the computing transformation operation comprises a computing adjustment operation.

In some embodiments, the computing transformation operation comprises a computing redemption operation.

In some embodiments, the transformed first information comprises an adjusted first information.

In some embodiments, the request comprises an approval request.

In some embodiments, a method is provided of routing computing operation information in a computing network. The method comprises: receiving, by a computing device, computing operation information comprising first information; recognizing, by the computing device, that the computing operation information relates at least in part to a first computing operation that is different from a second computing operation related to a computing operation-processing network; and routing, by the computing device, a first message comprising information related to the first computing operation to a first computing operation-processing computing device.

In some embodiments, the first message is routed to the first computing operation-processing computing device while not bypassing the computing operation-processing network related to the second computing operation.

In some embodiments, the first message is routed to the first computing operation-processing computing device while bypassing the computing operation-processing network related to the second computing operation.

### BRIEF DESCRIPTION OF THE DRAWINGS

FIG. 1 is a block diagram for routing signals in a complex computing network, in accordance with some embodiments of the invention; and

FIG. 2 is a block diagram of a method for routing signals in a complex computing network, in accordance with some embodiments of the invention.

FIG. 3 is a block diagram of another method for routing signals in a complex computing network, in accordance with some embodiments of the invention.

All of these drawings are illustrations of certain embodiments. The scope of the claims is not limited to the specific embodiments illustrated in the drawings and described below.

### DETAILED DESCRIPTION OF THE EMBODIMENTS

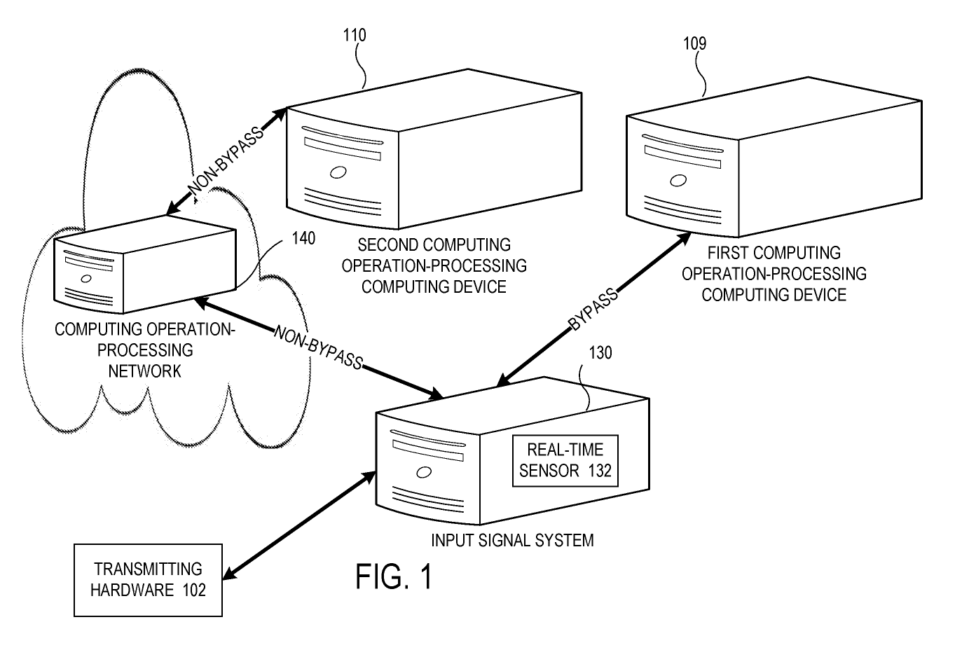

FIG. 1 is a block diagram of a complex computing network for routing signals in a complex computing network. FIG. 1 may comprise transmitting hardware 102, an input signal system 130 comprising a real-time sensor 132, a computing operation-processing network 140, a first computing operation-processing computing device 109, and a second computing operation-processing computing device 110. In some embodiments, the functionality of multiple devices in FIG. 1 may be combined in a single apparatus.

The various devices, servers, systems, hardware, etc. described in this disclosure may refer to, comprise, or be comprised in apparatuses, systems, devices, integrated circuits, sensors, users, entities, etc. A device described herein may comprise a processor. Any processor described herein may be an intelligent processor. An intelligent processor may be a processor that learns of signal routes based on historic signal routes to determine an optimal signal route for signals received at the input signal system from the transmitting hardware. A device may also comprise memory that stores computer-readable code, which when executed by the processor, causes the processor and/or other elements in the apparatus to perform the various methods described in this disclosure. In some embodiments, the term “signal” may refer to “data” or “information.” In some embodiments, even though some of the devices of FIG. 1 are not indicated as being connected, they may be connected to each other. In some embodiments, any signal described herein may be non-transitory. In some embodiments, any signal described herein may be transitory. In some embodiments, the terms “using” and “based on” may be equivalent.

In some embodiments, any system described herein may comprise a housing that includes various units. The units may include a processor, a memory unit, an input/output unit, and a communication interface. In some embodiments, a chipset may be disposed in the housing and may be interfaced with the processor such as a signal processor. The signal processor may be a customized or specialized signal processor configured one or more specific applications such as a redemption operations, a processing operation, etc. The chipset may have hardware (e.g., electronic components in an electronic circuit) for supporting various connections within the system (e.g., between units), or any other connection from the system to external systems or devices. The chipset may be an intelligent chipset for initiating a routing operation, such as an intelligent routing operation, as described herein.

The transmitting hardware may be associated with a first signal or may produce a signal. The transmitting hardware may be a computing device such as a mobile computing device. Alternatively, the transmitting hardware may be non-computing hardware (e.g., a physical card) with stored information (e.g., on a magnetic stripe). An input signal system may comprise a real-time sensor. In some embodiments, the real-time sensor may be a point-of-sale terminal such as a computing device (e.g., a mobile computing device, a non-mobile computing device). In some embodiments, the real-time sensor may refer to any real-time means or computing means. The transmitting hardware may transmit a signal and the real-time sensor may sense (e.g., determine, receive, etc.) the signal. Any sensor described in this disclosure may be a computing device. In some embodiments, a sensor in this disclosure may be a signal sensor. Any sensor described herein may be an analog, digital, or mixed-signal sensor.

In some embodiments, the input signal system comprises a point of sale system or terminal, which may also be an intelligent point of sale system or terminal. The computing operation-processing network (or just processing network) may comprise a card association transaction processing network. Signals or data received at the input system (e.g., from the transmitting hardware) may be transmitted to the second computing operation-processing computing device (or just second processing server), via the processing network, or directly to the first computing operation-processing computing device (or just first processing server) by bypassing the processing network. Either processing server executes a computing operation based on the received signals. However, the computing operations executed by the first processing server may be different from those executed by the second processing server. The processing server may return a message to the input signal system and/or the transmitting hardware either directly (e.g., in the case of the second processing server or the first processing server), or via the processing network (e.g., in the case of the second processing server). In some embodiments, the transmitting hardware and the input signal system may be housed in a single device. Any communication illustrated in FIG. 1 or described herein may be short or long range wireless or wired communication.

In some embodiments, a method is provided for bypass routing computing operation information in a computing network. The method comprises: receiving, by a computing device (e.g., the input signal system or any computing device connected to or in communication, either directly or indirectly, with the input signal system, any other system described herein, etc.), which may comprise an integrated circuit, computing operation (e.g., a transaction such as a point of sale transaction or other purchase transaction) information comprising first information (e.g., a transaction amount); recognizing, by the computing device, that the computing operation information relates at least in part to a first computing operation (e.g., a third party operation) that is different from a second computing operation (e.g., a card association transaction processing operation) related to a computing operation-processing network (e.g., a card association transaction network); and routing, by the computing device, a first message comprising information related to the first computing operation (or related to the performance of the first computing operation) to a first computing operation-processing computing device (e.g., a third party processing server) while bypassing the computing operation-processing network related to the second computing operation. In some embodiments, the computing device may be any other device used for purchase such as mobile device, mobile phone, or other smart device. In some embodiments, a third party operation may refer to any operation that is not a card association transaction processing operation. For example, a third party operation may refer to changing a transaction amount associated with the transaction conducted at the input signal system. As a further example, the third party operation may be a redemption operation. Any description or element with respect to any system or method may be applicable to or part of any other system or method as well.

In some embodiments, the first computing operation is processed at the first computing operation-processing computing device. In some embodiments, the first computing operation-processing computing device returns a second message related at least in part to the processing of the first computing operation (e.g., the processing status) to the computing device. The message may be returned directly or via one or more computing devices and/or networks.

In some embodiments, the first computing operation-processing computing device is further to determine whether a request in the information related to the first computing operation is eligible for approval. A request may refer to at least one of a transaction request, a redemption request, a transaction amount modifying request, etc.

In some embodiments, the computing device comprises a smart computing device that comprises one or more specialized or customized chipsets. In some embodiments, the first computing operation comprises a computing adjustment operation that adjusts an amount associated with the first information.

In some embodiments, the first computing operation additionally or alternatively comprises a computing redemption operation such that a portion of the amount associated with the first information is redeemed by a user associated with the first hardware.

In some embodiments, the second computing operation comprises an association computing operation. Such an operation may be any processing operation executed by or through the computing operation-processing network. In some embodiments, the second computing operation-processing computing device may comprise at least one of a card issuer processor and/or a merchant acquirer processor, etc. In some embodiments, the first computing operation-processing computing device and the second computing operation-processing computing device may refer to the same computing device, though, in other embodiments, they refer to different devices located in disparate locations.

In some embodiments, the first message is routed to the first computing operation-processing computing device via a third computing device (e.g., a merchant acquirer processor).

In some embodiments, a method is provided for transforming and routing computing operation information using a computing device (e.g., the input signal system or any computing device connected to or in communication with the input signal system, either directly or indirectly, any other system described herein, etc.). The method comprises: receiving, by a computing device, computing operation (e.g., a transaction such as a point of sale transaction or other purchase transaction) information comprising first information (e.g., a transaction amount); recognizing, by the computing device, that the computing operation information also comprises information related to a computing transformation operation (e.g., a redemption operation); performing, by the computing device, the computing transformation operation to produce transformed first information (e.g., an adjusted transaction amount after the redemption value is applied to the transaction amount); and routing, by the computing device, a message comprising a request (e.g., an approval request for an adjusted transaction amount, a redemption, etc.) for the transformed first information to a second computing device (e.g., a card issuer processor, a card processor, a payment processor, etc.) via a network (e.g., a card association processing network or a network different from the card association processing network).

In some embodiments, the computing transformation operation is different from a computing processing operation (e.g., a transaction processing operation, transaction approval operation, etc.) related to a computing processing-operation network. In some embodiments, the message is routed to the second computing device or a different computing device while bypassing the computing processing-operation network (e.g. the card association processing network) related to the computing processing operation.

In some embodiments, the computing transformation operation is performed at the second computing device, and the second computing device returns a second message related at least in part to the performing of the computing transformation operation (e.g., the message may include a redeemed amount or a reduced transaction amount) to the computing device.

In some embodiments, the computing device comprises a smart computing device. In some embodiments, the transforming of the computing operation information is necessarily rooted in computing technology. In some embodiments, the computing transformation operation comprises a computing adjustment operation.

In some embodiments, the computing transformation operation comprises a computing redemption operation. In some embodiments, the transformed first information comprises adjusted first information. In some embodiments, the request comprises an approval request.

In some embodiments, any of the devices described herein may comprise application programming interfaces (APIs) for communicating with any of the other devices described herein. These APIs may be specialized non-generic APIs that are developed for the particular purpose of communicating with particular devices. In some embodiments, a non-transitory computer-readable medium comprising code is provided for causing a computing device to perform the various methods described herein.

In some embodiments, the various devices of FIG. 1 correspond to and are the equivalent of any devices in the applications incorporated-by-reference below, even though some of the devices of FIG. 1 in the instant application carry different names from the devices described in the applications incorporated-by-reference below. In some embodiments, the various devices of FIG. 1 perform the same or similar operations as the devices described in the applications incorporated-by-reference below.

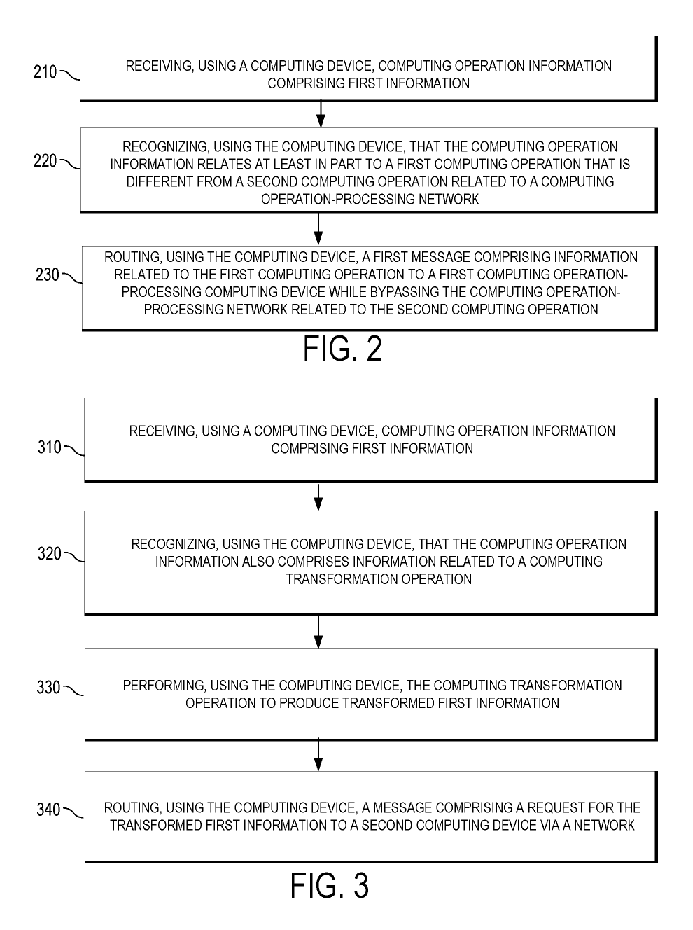

FIG. 2 is a block diagram of a method for routing computing operation information in a computing network. The various blocks of FIG. 2 may be executed in a different order from that shown in FIG. 2. At block 210, the method comprises receiving, using a computing device, computing operation information comprising first information. At block 220, the method comprises recognizing, using the computing device, that the computing operation information relates at least in part to a first computing operation that is different from a second computing operation related to a computing operation-processing network. At block 230, the method comprises routing, using the computing device, a first message comprising information related to the first computing operation to a first computing operation-processing computing device while bypassing the computing operation-processing network related to the second computing operation.

FIG. 3 is a block diagram of another method for routing computing operation information in a computing network. The various blocks of FIG. 3 may be executed in a different order from that shown in FIG. 3. At block 310, the method comprises receiving, using a computing device, computing operation information comprising first information. At block 320, the method comprises recognizing, using the computing device, that the computing operation information also comprises information related to a computing transformation operation. At block 330, the method comprises performing, using the computing device, the computing transformation operation to produce transformed first information. At block 340, the method comprises routing, using the computing device, a message comprising a request for the transformed first information to a second computing device via a network.

In some embodiments, any routing or communication described herein may be via any short range (e.g., near field communication, Bluetooth, Bluetooth Low Energy, etc.) or long range wireless transmission mechanisms (e.g., cellular, Wi-Fi, etc.). In some embodiments, the frequency of transmission may not be limited to any particular frequency of the electromagnetic spectrum. In alternate embodiments, any routing described herein may be via wires or wired technology.

The present invention may have uses in many fields, such as computing science and software, electronic commerce, digital signal processing, medical software, etc. Any exemplary uses are described herein are for illustration purposes only. In some embodiments, any signals described herein may comprise payment information such as payment card information. In some embodiments, the transmitting or receiving hardware hardware may comprise a card such as a payment card, an identification card, a loyalty card, etc., or a device such as a payment device, or mobile device such as a mobile phone or watch.

This application claims priority to and is a continuation-in-part application of U.S. patent application Ser. No. 14/330,768, filed on Jul. 14, 2014, which is a continuation of U.S. patent application Ser. No. 13/584,632, filed on Aug. 13, 2012, now U.S. Pat. No. 8,825,522, issued on Sep. 2, 2014, which is a continuation of U.S. patent application Ser. No. 13/226,210 filed on Sep. 6, 2011, now U.S. Pat. No. 8,244,580, issued on Aug. 14, 2012, which is a continuation of U.S. patent application Ser. No. 11/381,507, filed on May 3, 2006, now U.S. Pat. No. 8,036,934, issued on Oct. 11, 2011, which is a divisional application of U.S. patent application Ser. No. 10/262,767, filed on Oct. 1, 2002, now U.S. Pat. No. 7,593,862, issued on Sep. 22, 2009, which is a continuation-in-part application of U.S. patent application Ser. No. 10/081,257, filed on Feb. 22, 2002, which is abandoned and application Ser. No. 09/611,672, filed on Jul. 7, 2000, now U.S. Pat. No. 6,868,426, issued on Mar. 15, 2005, both of which claim priority to the following provisional patent applications: 60/142,611, filed Jul. 7, 1999, and 60/191,352, filed Mar. 22, 2000. The above applications-Ser. Nos. 14/330,768, 13/584,632, 13/226,210, 11/381,507, 10/262,767, 10/081,257, 09/611,672, 60/142,611, and 60/191,352-are hereby incorporated by reference into this application. This application is further related to commonly owned U.S. patent application Ser. No. 09/309,989, filed on May 11, 1999, now U.S. Pat. No. 6,385,591, issued on May 7, 2002, which is also hereby incorporated by reference herein.

As used herein, the term “real-time” or “dynamically” in any context may refer to any of current, immediately after, simultaneously as, substantially simultaneously as, a few microseconds after, a few milliseconds after, a few seconds after, a few minutes after, a few hours after, a few days after, a period of time after, etc. In some embodiments, the term “modify” or “modification” may be interchangeably used with the term “transform” or “transformation.”

The present disclosure provides several important technical advantages that will be readily apparent to one skilled in the art from the figures, descriptions, and claims.

Moreover, while specific advantages have been enumerated above, various embodiments may include all, some, or none of the enumerated advantages.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

1. A method of bypass routing computing operation information in a computing network, the method comprising:
receiving, using a computing device, computing operation information comprising first information;
recognizing, using the computing device, that the computing operation information relates at least in part to a first computing operation that is different from a second computing operation related to a computing operation-processing network; and
routing, using the computing device, a first message comprising information related to the first computing operation to a first computing operation-processing computing device while bypassing the computing operation-processing network related to the second computing operation.

2. The method of claim 1, wherein the first computing operation is processed at the first computing operation-processing computing device.

3. The method of claim 2, wherein the first computing operation-processing computing device returns a second message related at least in part to the processing of the first computing operation to the computing device.

4. The method of claim 1, wherein the first computing operation-processing computing device is further to determine whether a request in the information related to the first computing operation is eligible for approval.

5. The method of claim 1, wherein the computing device comprises a smart computing device.

6. The method of claim 1, wherein the first computing operation comprises a computing adjustment operation.

7. The method of claim 1, wherein the first computing operation comprises a computing redemption operation.

8. The method of claim 1, wherein the second computing operation comprises an association computing operation.

9. The method of claim 1, wherein the first message is routed to the first computing operation-processing computing device via a third computing device.

10. A method of transforming and routing computing operation information using a computing device, the method comprising:
receiving, using a computing device, computing operation information comprising first information;
recognizing, using the computing device, that the computing operation information also comprises information related to a computing transformation operation;
performing, using the computing device, the computing transformation operation to produce transformed first information; and
routing, using the computing device, a message comprising a request for the transformed first information to a second computing device via a network.

11. The method of claim 10, wherein the computing transformation operation is different from a computing processing operation related to a computing processing-operation network.

12. The method of claim 11, wherein the message is routed to the second computing device while bypassing the computing processing-operation network related to the computing processing operation.

13. The method of claim 12, wherein the computing transformation operation is performed at the second computing device, and wherein the second computing device returns a second message related at least in part to the performing of the computing transformation operation to the computing device.

14. The method of claim 10, wherein the computing device comprises a smart computing device.

15. The method of claim 10, wherein the computing transformation operation comprises a computing adjustment operation or a computing redemption operation.

16. The method of claim 10, wherein the transformed first information comprises an adjusted first information.

17. The method of claim 10, wherein the request comprises an approval request.

18. A method for routing computing operation information in a computing network, comprising:
receiving, by a computing device, computing operation information comprising first information; recognizing, by the computing device, that the computing operation information relates at least in part to a first computing operation that is different from a second computing operation related to a computing operation-processing network; and
routing, by the computing device, a first message comprising information related to the first computing operation to a first computing operation-processing computing device.

19. The method of claim 18, wherein the first message is routed to the first computing operation-processing computing device while not bypassing the computing operation-processing network related to the second computing operation.

20. The method of claim 18, wherein the first message is routed to the first computing operation-processing computing device while bypassing the computing operation-processing network related to the second computing operation.
